(19) United States
(12) Patent Application Publication
(10) Pub. No.: US 2017/0292274 A1
(43) Pub. Date: Oct. 12, 2017

(54) Panel Mount Compression System

(71) Applicant: HDI Railing Systems, Columbia, PA (US)

(72) Inventor: Kevin Downs, Lancaster, PA (US)

(73) Assignee: HDI Railing Systems, Columbia, PA (US)

(21) Appl. No.: 15/096,566

(22) Filed: Apr. 12, 2016

(51) Int. Cl. E04F 11/18; F16B 5/06

(52) U.S. Cl. CPC E04F 11/1812; E04F 11/1853; F16B 5/0628

(57) ABSTRACT

A panel retention device is provided and includes a compression pad, a compression plate, a threaded disk, and an adjustable flange. The compression pad has a rectangular cross section and includes a plate opposing surface. The compression plate has a rectangular cross section and includes a pad support surface facing the compression pad and a disk support surface. The threaded disk extends from the disk support surface, and the adjustable flange is removably threaded onto the threaded disk.

### FIELD OF THE INVENTION

The invention relates to a panel mount compression system and, more particularly, to a panel mount compression system having a panel retention device used to support a panel or panels for use as a partition, railing, guard, or wall.

### BACKGROUND

Tempered glass panels are popular architectural elements in commercial, business, and residential buildings due to their transmission of light and unobstructed sight lines. These panels are used in guard rails, partitions, and wall structures. The panels are installed using linear shoes that allow the panels to be rigidly positioned and attached to a base or wall support. There are several disadvantages to existing systems. Glass panels are easily damaged during installation, adjustment, removal, or reinstallation. Therefore, innovative tools and methods for minimizing such damage and increasing the ease of installing, aligning, adjusting, removing, and reinstalling the panels are of significant interest in the industry.

### SUMMARY

A panel mount compression system having a retention device is provided and includes a compression pad, a compression plate, a threaded disk, and an adjustable flange. The compression pad has a rectangular cross section and includes a plate opposing surface. The compression plate has a rectangular cross section and includes a pad support surface facing the compression pad and a disk support surface. The threaded disk extends from the disk support surface, and the adjustable flange is removably threaded onto the threaded disk.

### BRIEF DESCRIPTION OF THE DRAWINGS

The invention will now be described by way of example with reference to the accompanying Figures of which:

FIG. 1 is a perspective view of a panel mounting system according to the invention;

FIG. 2 is a side view of the panel mounting system according to FIG. 1;

FIG. 3 is a perspective view in cross section of a panel retention device of the assembled panel mounting system according to the invention;

FIG. 4 is a cross-sectional view of the panel retention device of FIG. 3;

FIG. 5 is a partial perspective view in cross-section of a portion of the panel mounting system according to the invention;

FIG. 6 is a perspective view in cross-section of the panel mounting system according to the invention;

FIG. 7 is a cross-sectional detail view of the panel mounting system according to the invention;

FIG. 8 is a side elevation view of the panel mounting system according to the invention showing a tightening tool for use with the panel mounting system;

FIG. 9 is an exploded perspective assembly view of the panel mounting system according to the invention;

FIG. 10 is a perspective view in cross-section of the panel mounting system according to the invention;

FIG. 11 is a cross-sectional view of the assembled panel mounting system taken along line 11-11 of FIG. 10;

FIG. 12 is another cross-sectional view of the assembled panel mounting system, wherein the panel is compressed into place;

FIG. 13 is another cross-sectional view of the assembled panel mounting system, wherein the panel is not compressed into place;

FIG. 14 is an exploded perspective assembly view of a panel retention device according to the invention;

FIG. 15 is a partially exploded perspective assembly view of the panel retention device of FIG. 14;

FIG. 16 is a perspective view of a assembled compression pad, a compression plate, a plurality of alignment posts, and a threaded disk of the panel retention device according to the invention;

FIG. 17 is a cross-sectional view taken along line 17-17 of FIG. 16;

FIG. 18 is a front view of the flange of FIG. 16;

FIG. 19 is a cross-sectional view taken along line 19-19 of FIG. 18;

FIG. 20 is a top view of the enlarged portion identified in FIG. 19;

FIG. 21 is a perspective view of the flange according to the invention;

FIG. 22 is a perspective view of a first L-shaped compression pad according to the invention;

FIG. 23 a side view of the first L-shaped compression pad of FIG. 22.

FIG. 24 is a perspective view of a second L-shaped compression pad according to the invention;

FIG. 25 is a side view of the second L-shaped compression pad of FIG. 24.

FIG. 26 is a cross-sectional view of a panel mounting system according to the invention;

FIG. 27 is another cross-sectional view of a panel mounting system according to the invention;

FIG. 28 is a perspective view in cross-section of an assembled panel mounting system according to the invention; and

FIG. 29 is a cross-sectional view of the assembled panel mounting system taken along line 29-29 of FIG. 28.

### DETAILED DESCRIPTION OF THE EMBODIMENT(S)

The subject matter of invention will be disclosed in the accompanying description and drawings which present several embodiments. The claimed invention is a system for securing a panel to serve as a partition, guard, railing, or wall. The system is more particularly designed to secure glass panels that allow for the transmission of light. Glass panels for use with the invention are available in a variety of designs, textures and colors. The size, thickness, and type of glass should be selected to comply with all applicable building codes, engineering standards, and safety requirements. Edges and corners are typically polished and blunted respectively to ensure user safety. The invention can also accommodate the use of curved glass and other custom designs. Additionally, the system may be used with panels of various materials including metal that is solid or perforated, materials structured or woven within a frame such as strung cable that is metal, synthetic, or a natural material such as jute. The system may also be used with panels of plywood, particle board, polycarbonate, or other rigid polymeric materials. Panel thickness is determined by the requirements of the site and loading requirements. Therefore, the term “panel” encompasses all materials that may be supported with the invention.

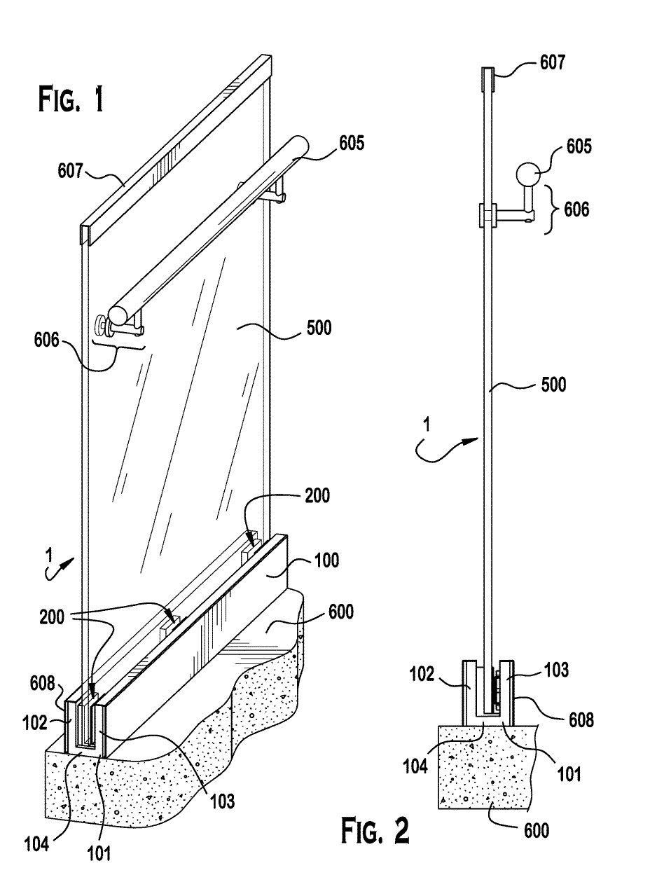

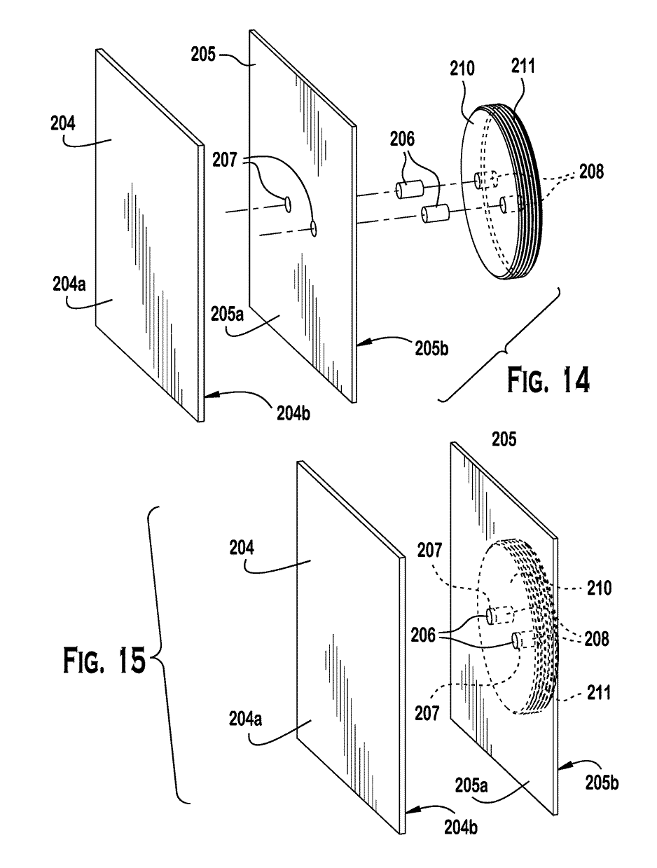

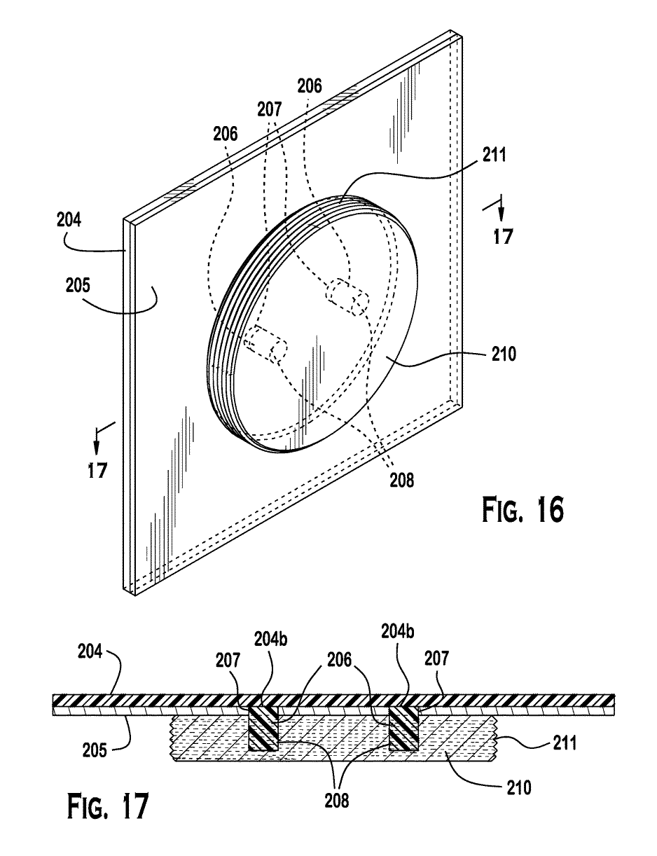

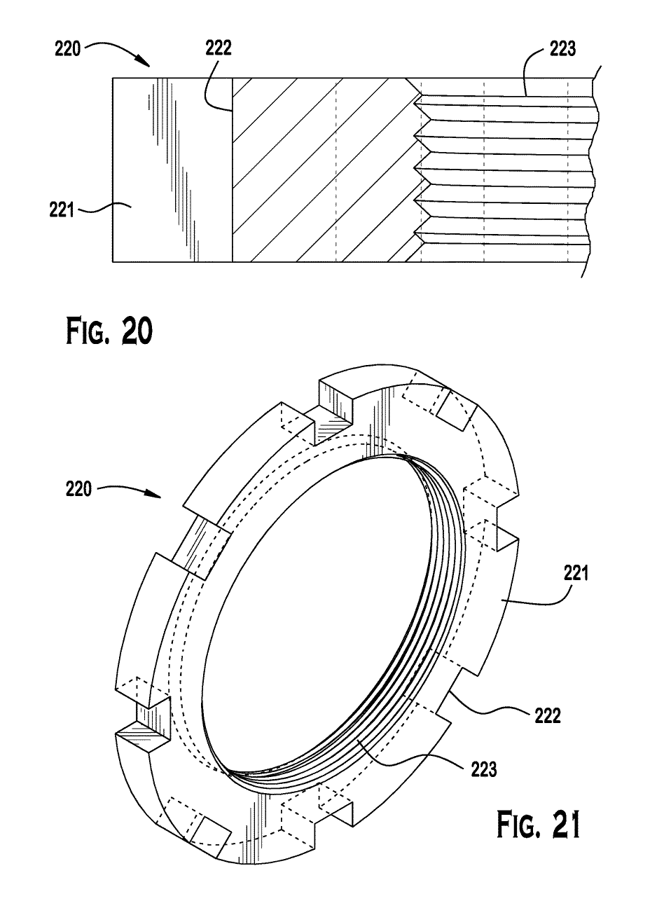

Referring now to the accompanying drawings wherein reference numerals are used consistently throughout the views to designate identical or corresponding elements, FIG. 1 shows generally a panel mounting system 1 (hereinafter referred to as “mounting system”) in use and installed on an anchor site 600. The mounting system 1 is comprised of the following major components: a panel retention device 200 for receiving a panel 500 and contained within a base shoe 100 which may be attached at an anchor site 600. The anchor site may be a floor, wall, step, or other support. These elements are described in detail below. FIGS. 1-29 illustrate various embodiments, aspects, and features according to the invention.

In both FIGS. 1 and 2, the panel 500 is shown installed with use of the mounting system 1. In FIG. 1, the lower edge of the panel 500 is held in base shoe 100 within a plurality of panel retention devices 200 fitted into the receiving channel 101. In FIGS. 1 and 2, the panel 500 is shown with a hand railing 605 installed on a first face of the panel 500, hardware 606 securing the hand railing 605 to the panel 500, and a panel cap 607 sheathing the top edge of panel 500. The base shoe 100 may optionally be clad in a housing 608.

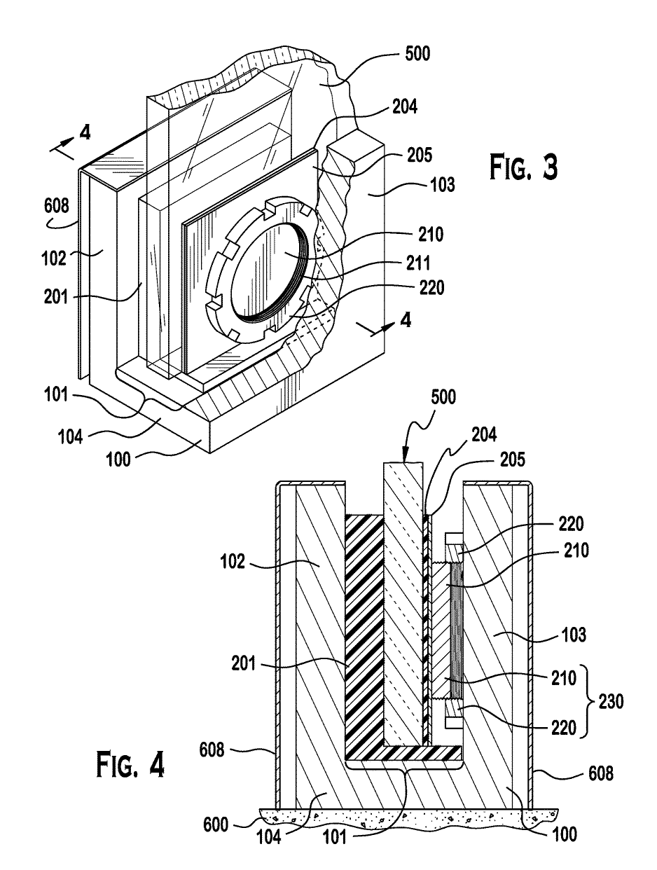

Now referring to FIGS. 3-13, the panel retention device 200 is shown in various views. FIGS. 3-4, 6-7, and 9-13 show the panel retention device 200 assembled and fitted into a U-shaped receiving channel 101 formed by first and second sidewalls 102, 103 and a bottom 104 of base shoe 100.

The dimensions of the base shoe 100 are determined by the demands to be placed on the partition, railing, guard, or wall and the characteristics (strength, weight, width, etc.) of the panel to be held in place by the mounting system. One of skill in the art is capable of determining the optimum dimensions of the base shoe. The dimensions of the elements of the panel retention device 200 will reflect the dimensions of the base shoe and the demands to be placed on the mounting system 1.

The base shoe 100 is typically rigid and continuous, running the entire length of the lower edge of the panel 500. “Continuous” refers both to a single metal extrusion or formed piece as well as to a base shoe constructed of a plurality of smaller pieces joined or spliced together to form a functionally continuous piece. The length of the base shoe or the number of pieces used to form the base shoe is determined by the linear dimension of the partition, guard, railing, or wall. Preferably, the extent of splicing of the pieces to form the base shoe is held to a minimum to reduce assembly activities and weight. Base shoes 100 are made of a variety of metals. Preferably they are made of stainless steel, aluminum, brass, or any material sufficiently strong and durable for the desirable application. These materials may be finished in a variety of textures for aesthetic purposes. Various properties may influence the choice of the metal of the base shoe. These properties include weight, strength, non-corrosiveness, expense, and an ability to be finished, textured, anodized, or coated as desired.

Generally, the panel retention device 200 includes an L-shaped compression pad 201, a compression pad 204, a compression plate 205, a threaded disk 210, an adjustable flange 220, and a plurality of alignment supports 206.

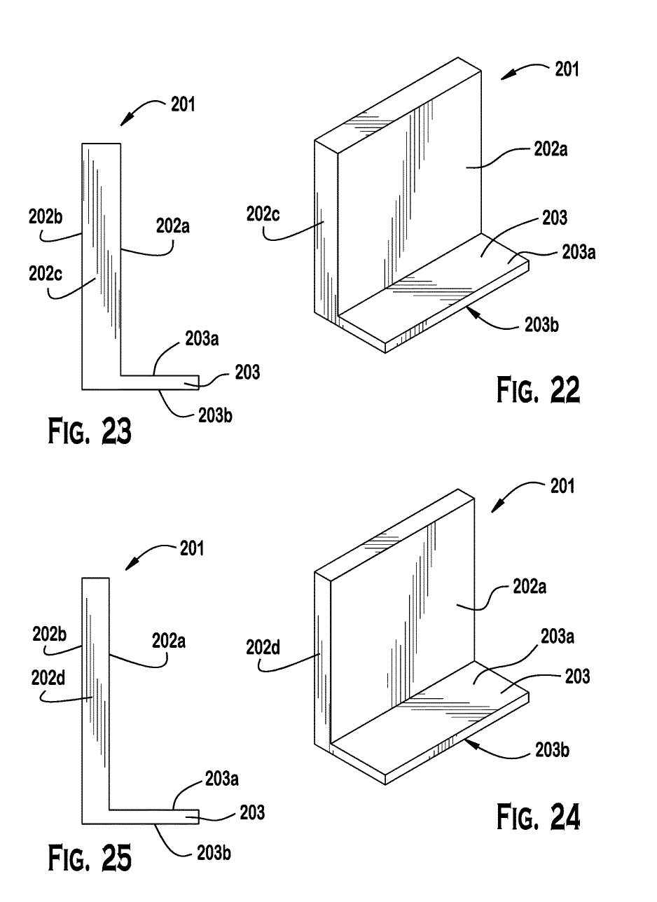

Now referring to FIGS. 22-25, the L-shaped compression pad 201 is shown with a square-shaped planar vertical back portion 202 having two major planar surfaces positioned opposite from one another: a panel support surface 202a and a sidewall support surface 202b. The side width of the vertical back portion 202 may be thicker 202c (as in FIGS. 22-23) or thinner 202d (as in FIGS. 24-25) as required by the width of the panel 500 that will be installed.

The L-shaped compression pad 201 is shown with a rectangular base portion 203 having two major planar surfaces positioned opposite from one another: a panel edge support surface 203a and a bottom support surface 203b. The width of the base portion 203 is determined by the width of the receiving channel 101. The distance between the panel edge support surface 203a and a bottom support surface 203b is determined by the load of the panel 500 to be inserted into the receiving channel 201.

As shown in FIGS. 14-17, the compression pad 204 is a square-shaped planar member in the embodiment shown. The compression pad 204 includes two major planar surfaces positioned opposite from one another: a panel support surface 204a and a plate support surface 204b.

The L-shaped compression pad 201 and the compression pad 204 are made of rubber or synthetic polymeric material that cushion and prevent contact of the panel 500 with the base shoe 100 and other elements that may scratch or damage the panel 500. This is of particular concern when the panel is composed of glass. Preferably, the material selected for the compression pads 201, 204 has good chemical stability and maintains its cushioning ability over a wide temperature range. The selected material preferably also has the capacity to evenly distribute pressure or force from one component to another, for example as here from the metal threaded expansion unit 230 to the panel 500. Materials suitable for the L-shaped compression pad 201 and the compression pad 204 are ethylene Propylene Diene Monomer (EPDM), nylon, High Density polyethylene (HDPE), vinyl, neoprene, or other type of polymer. Other suitable materials are known to those of skill in the art. Additionally, the materials chosen for the compression pads 201, 204 help to prevent the panel 500 from slipping out of the base shoe 100.

As further shown in FIGS. 14-17, the compression plate 205 is a square-shaped planar member in the embodiment shown. The compression plate 205 includes two major planar surfaces positioned opposite from one another: a pad support surface 205a and a disk support surface 205b. The compression plate 205 includes a plurality of alignment support receiving passageways 207 (hereinafter referred to as “passageway”) each sized to accommodate an alignment support 206. In this embodiment, the support 206 is cylindrically shaped. The passageway 207 extends through the compression plate 205 from pad support surface 205a to the disk support surface 205b. In the embodiment shown, the compression plate 205 includes a pair of passageways 207.

As further shown in FIGS. 14-17, the threaded disk 210 is a cylindrical member having a body with a plurality of threads 211 disposed along an outer surface thereof. The threaded disk 210 also includes two major planar surfaces positioned opposite from one another and perpendicular to the threaded surface 211: a compression plate support surface 210a and a second sidewall-facing surface 210b. The threaded disk 210 also includes a plurality of cylindrically-shaped alignment support receiving sockets 208 (herein after referred to as “socket”). Each socket 208 extends within the threaded disk 210 perpendicularly from the compression plate support surface 210a to a point determined by the length of the alignment support 206 minus the length of the passageway 207 through the compression plate 205. Each socket 208 accommodates an alignment support 206 described in more detail below and is sized to hold the threaded disk 210 in place when compressing force is applied as described below. In the embodiment shown, the compression plate 205 includes a pair of sockets 208, each socket containing alignment support 206.

In FIG. 17, the threaded disk 210 is shown with two alignment supports 206 inserted within sockets 208, the alignment supports 206 extending through the passageways 207 of compression plate 205 to contact plate support surface 204b of the compression pad 204.

As shown in FIGS. 14 through 17, the alignment supports 206 are preferably cylindrically-shaped, solid members and are sized to fit within the circumference of passageways 207 and sockets 208. In the shown embodiment, the alignment supports 206 are formed of rubber or polymeric materials chosen for the particular application, but are not necessarily of the same material as the compression pads 201, 204. One of skill in the art will select a material for alignment support 206 with characteristics sufficient strong to hold the threaded disk 210 in place. The plurality of alignment supports 206 prevent the threaded disk from being dislodged, sheared off, or from twisting upon the application of force on flange 220 by tightening tool 300 when compressing force is applied as described below. Alignment supports 206 may be other than cylindrically-shaped provided that this alignment functionality is retained.

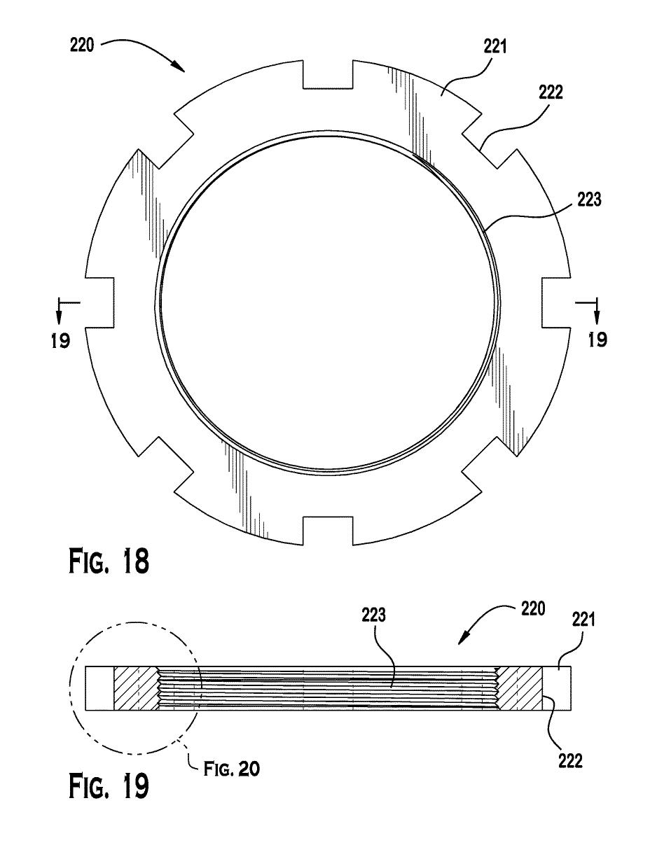

As shown in FIG. 18 through 21, the adjustable flange 220 (hereinafter referred to as “flange”) is a disk-shaped member having a plurality of spaced teeth 221 positioned at its circumference and extending away from a center thereof. Accordingly, the plurality of teeth 221 provides a plurality of tool-receiving notches 222 between each tooth 221. The flange 220 further includes a threaded disk receiving passageway 223 extending through a body of the flange 220 from front to back and completely there through. In the embodiment shown, the threaded disk receiving passageway 223 corresponds with the threaded disk 210. The threaded disk-receiving passageway 223 includes a threaded interior surface 223a that correspond to the threads 211 of the threaded disk 210.

The compression plate 205, the threaded disk 210, the flange 220, and the tightening tool 300 are preferably made of aluminum, stainless steel, brass, or other metal selected for properties suitable to securely support the panel 500.

The width of the panel 500 to be secured will determine the dimensions of the base shoe 100 as well as the dimensions of the components of the panel retention device 200. The square-shaped planar dimensions of the vertical back portion 202, the compression pad 204, and the compression plate 205 are the same to provide a commonly-sized surface upon which to apply a compressing force on the panel 500. The planar dimensions of the vertical back portion 202, the compression pad 204, and the compression plate 205 also reflect the depth of receiving channel 101.

Referring back to referring to FIGS. 3-13, the elements of each panel retention device 200 are positioned in the receiving channel 101. The number of independent, preferably evenly spaced panel retention devices 200 is that determined by the installer to be required to securely restrain the panel 500.

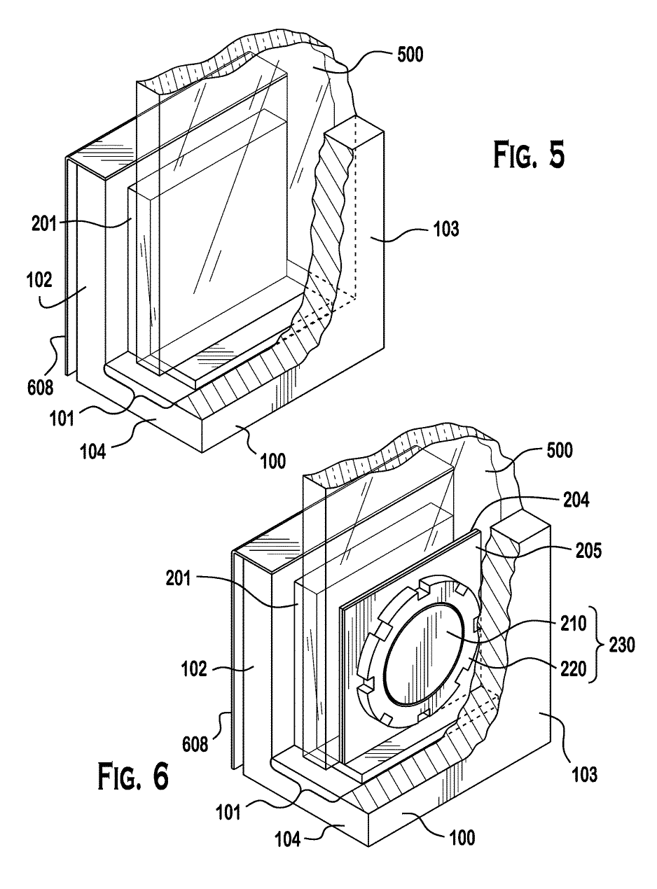

As shown in FIG. 5, within the receiving channel 101 of base shoe 100, the vertical portion 202c of the L-shaped compression pad 201 is positioned against a first sidewall 102. The bottom portion 203c of the L-shaped compression pad 201 is positioned in the bottom 204 of the U-shaped receiving channel 101 of the base shoe 100. The panel 500 is positioned with its first face 500a against panel support surface 202a of the L-shaped compression pad 201. The panel support surface 204a of the compression pad 204 is positioned against the second face 500b of panel 500. The compression plate support surface 204b of compression pad 204 is positioned adjacent to the compression pad support surface 205a of the compression plate 205. The disk support surface 205b of compression plate 205 is positioned adjacent to the compression plate support surface 210a of the threaded disk 210.

Referring to FIG. 17, the compression plate 205 is aligned with the threaded disk 210, the threaded disk 210 having a plurality of supports 206 contained within corresponding sockets 208 and passageways 207 respectively.

Referring to FIG. 6, the flange 220 is positioned about the threaded disk 210. The threaded disk 210 and the flange 220 when screwed together form a threaded expander unit 230 which, when adjusted as described below, provides the compression force to securely retain the panel 500 in place.

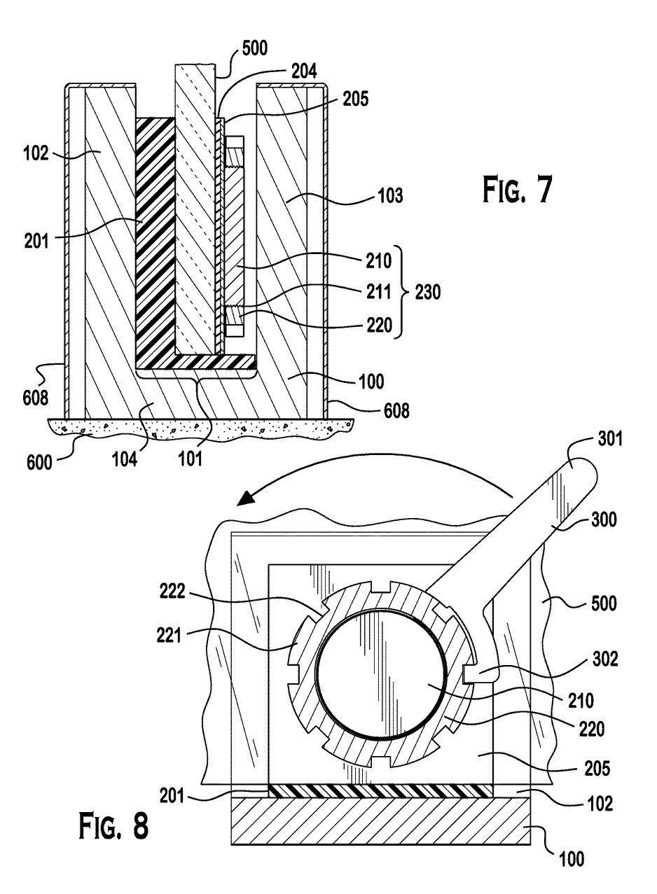

FIG. 7 shows in cross-section the fully assembled panel retention device 200 with the flange 220 screwed adjustably onto the threaded disk 210 to form the threaded expander unit 230. The lower edge of panel 500 is inserted into the receiving channel 101 to rest on the top planar surface 203a of the base portion 203 of the L-shaped compression pad 201.

The remaining elements of the panel retention device 200 are assembled between the panel surface 500b and the second sidewall 103 of the base shoe 100: the compression pad 204, the compression plate 205 aligned by a plurality of alignment supports 206 with the threaded disk 210 threaded with flange 220. FIG. 7 illustrates that the flange 220 is not yet in contact with the second sidewall 103 of the base shoe 100, i.e., that the threaded expansion unit 230 has not yet been expanded to apply the needed force to hold the panel 500 in place.

Referring now to FIG. 8, the cut away view shows a tightening tool 300 having a pawl 302 fitting between adjacent spaced teeth 221 of the flange 220. Moving the grip end 301 of the tightening tool 300 in the direction indicated by the arrow in FIG. 8 increases the depth of the threaded expander unit 200. Repositioning the pawl 302 of tightening tool 300 to repeat the expansion motion creates sufficient force to hold the panel 500 in place. Conversely, moving the grip end 301 of the tightening tool 300 in the opposite direction to that indicated by the arrow in FIG. 8 decreases the depth of the threaded expander unit 200 and permits adjustment or removal of the panel 500.

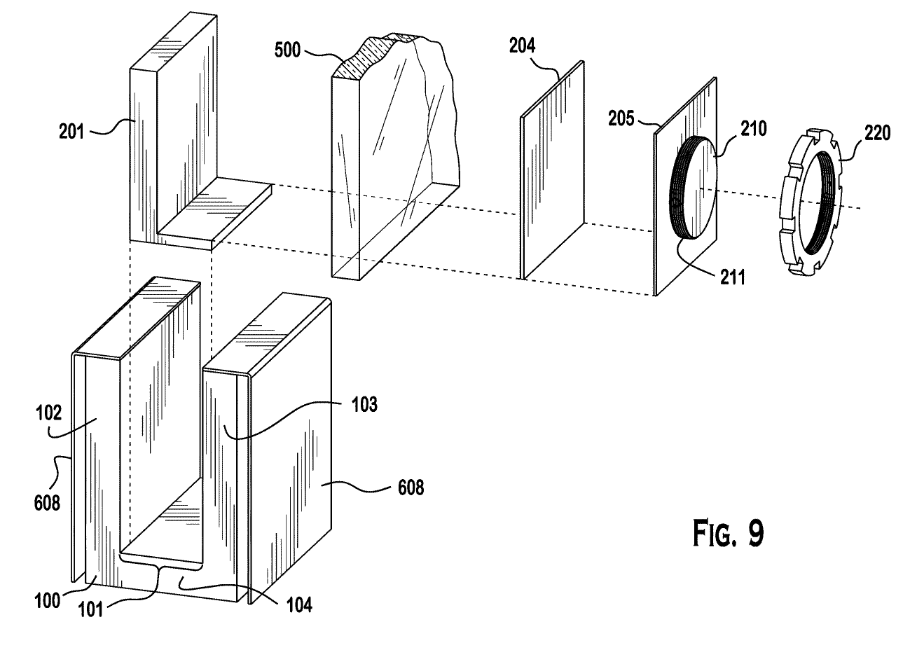

Referring now to FIG. 9, the components housed within the base shoe 100 are shown in an exploded diagram. The base shoe 100, clad in an exterior housing 104, has a generally U-shaped receiving channel 101 formed by the bottom 104 and the first and second sidewalls 102, 103. Within the receiving channel 101 are inserted the following components: the L-shaped compression pad 201, the panel 500, the compression pad 204, the compression plate 205, the threaded disk 210, and the flange 220. The dimensions of compression pads 201, 204, the compression plate 205, the threaded disk 210, and the flange 220 is in keeping with the height of the base shoe 100 so that the panel retention device 200 is housed wholly within the base shoe 100.

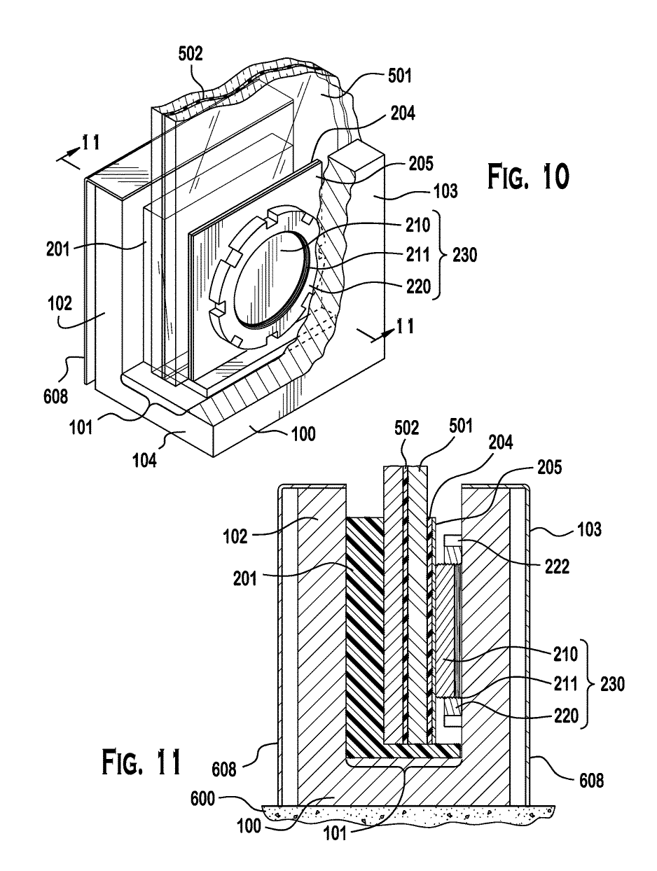

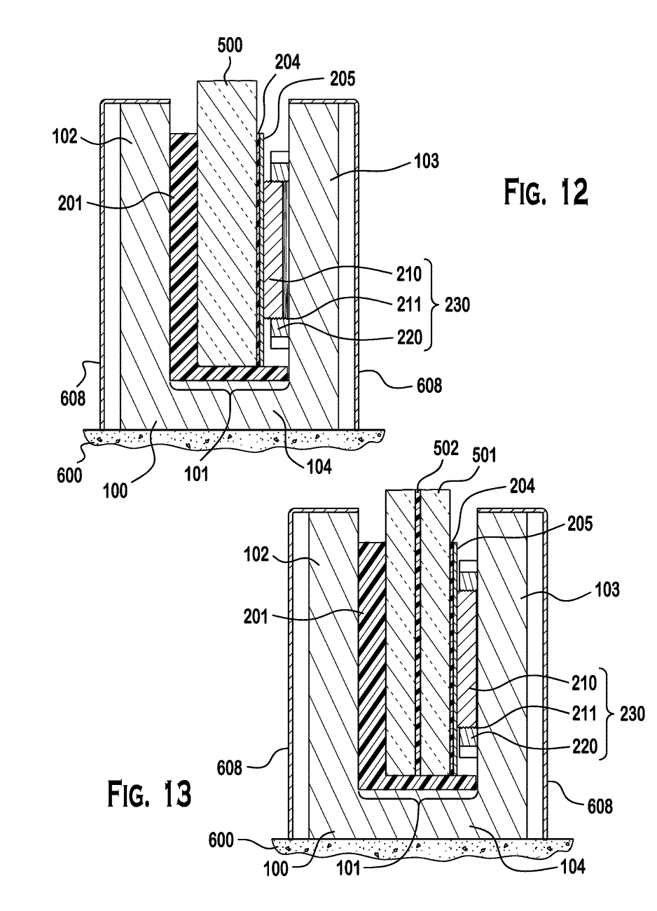

Referring now to FIGS. 10-13, the components are shown assembled. FIG. 10 shows a further embodiment according to the invention wherein the panel 500 is more particularly a multiple-layered glass panel 501 and includes an insulating layer 502. FIG. 11 shows, on the cross-sectional line 11 of FIG. 10, an embodiment according to the invention wherein the threaded expander unit 230 has been expanded by use of the tightening tool 300 as described above to create sufficient force to maintain the glass panel 501 in the desired position. FIGS. 12 and 13 illustrate two embodiments according to the invention wherein panels 500, 501 of different widths can be accommodated by the threaded expander unit 230 in the panel retention device 200.

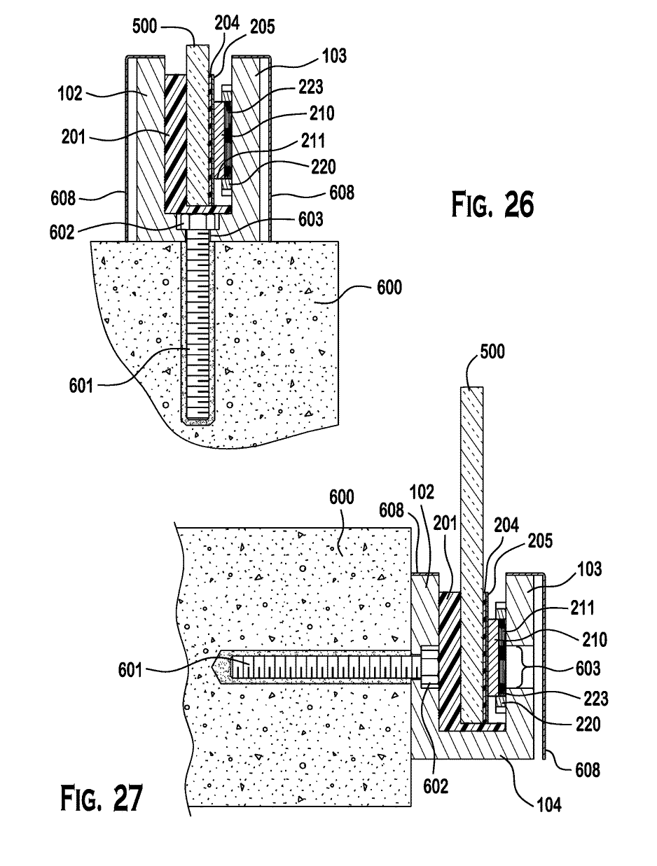

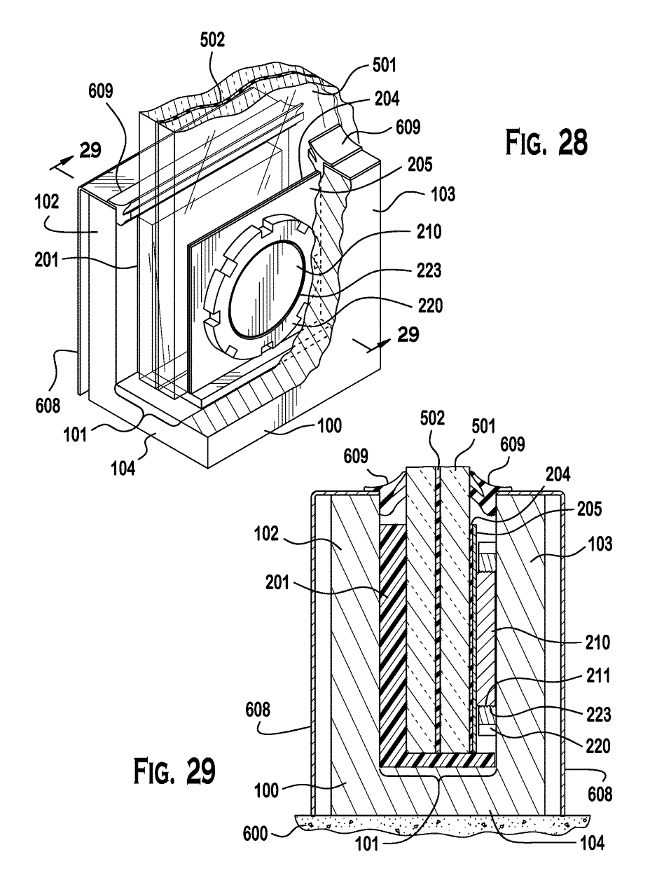

Turning now to FIGS. 26 and 27, embodiments according to the invention for securing the mounting system 1 to an anchor site 600 will be detailed. One of skill in the art is acquainted with suitable hardware to affix the mounting system 1 to an anchor site. FIG. 26 is a cross-sectional view of the panel mounting system 1 anchored to a horizontal anchor site 600 such as a floor, concrete pad, or similarly oriented surface. FIG. 27 is a cross-sectional view of the panel mounting system 1 anchored to a vertical anchor site 600 such as a wall, a vertical surface of a step or riser, or similarly oriented surface. Regardless of the orientation of the anchor site 600, the installer fits the anchor site 600 with a bolt 601 and nut 602 sized and selected to hold the mounting system 1 and panel 500 in place. The base shoe 100 is equipped with spaced passageways 603 through which the bolt 601 is fitted. The orientation of the anchoring site 600 will determine if the spaced passageways 603 are located in the sidewalls 102, 103 or in the bottom 104 of the base shoe 100. The bolt 601 may be installed into existing anchor sites 600 with a drill or otherwise fixed in place during the construction of a concrete pad or step.

FIGS. 28 and 29 will now be discussed in detail. FIG. 28 is a perspective, partially cut-away view of one compression assembly unit 200 and multi-layered glass panel 501. A seal 609 is positioned to exclude moisture or debris from entering the area between the first and second sidewalls 102, 103 and the respective opposing sides of the panel 500. The seal 609 is made of a resin or polymeric material.

The outward facing surfaces of the base shoe 100 optionally may be clad with a housing 608. The housing 608 may serve decorative or aesthetic purposes and additionally serves to hide from view the passageways and materials used to secure the base shoe 100 to an anchoring site 600.

To assemble the mounting system 1, the anchor site 600 selected is prepared to receive the anchor bolt 601 and nut 602 or other suitable hardware known to those of skill in the art. The base shoe 100 is generally anchored on a concrete site. The hardware is typically expansion anchors, threaded rods and epoxy, log bolts, or through regularly spaced bolts. Other suitable anchoring hardware and methods may be used. The base shoe 100 is secured to the anchor site 600.

The panel retention devices 200 are inserted into the receiving channel 10: the L- shaped compression pad 201 is inserted into the receiving channel against sidewall 102 and the panel 500 is inserted and cushioned on the lower section 203 of the L-shaped compression pad 201. Against the opposing side 500b of the panel 500 is positioned the compression pad 204, the compression plate 205, and the threaded expander unit 230 as described and shown herein. It is understood that these components are assembled in the order described. The tightening tool 300 is then used as described above to expand the threaded expander unit 230 until the desired force to hold the panel 500 securely in place is attained. The number and positioning of the panel retention devices 200 per panel inserted into the receiving channel 101 is determined by the overall demands placed on the system 1 to support the panel 500 and the use to which the mounting system 1 supporting the panel 500 will be put. The height and width of the panel, partition, guard, railing, or wall, the material from which the panel(s) are made, and the force expected to be applied to the panel by wind or individuals interacting with the system are some of the considerations to be considered in determining the number of panel retention devices installed per panel. One of skill in the art will understand that at least two adjustable compression units are needed for the panel to be satisfactorily held in place.

One of skill in the art can use the tightening tool 300 to adjust the position of the panel for alignment relative to adjacent panels. The tightening tool 300 is also used when the panel or base shoe 100 is in need of repair, removal, or reinstallation.

The mounting system 1 may also be used to frame other edges of the panel 500 than just the bottom edge, resulting in a matching sheathing effect. This embodiment is useful where the panel 500 permits securing the panel 500 at more than the lower edge of the panel. For example, the panel 500 may additionally be secured to a wall or to a ceiling anchor site. In this embodiment, the mounting system 1 is configured to accommodate using base shoes 100 on adjoining edges of a panel.

The foregoing illustrates some of the possibilities for practicing the invention. Many other embodiments are possible within the scope and spirit according to the invention. It is, therefore, intended that the foregoing description be regarded as illustrative rather than limiting, and that the scope according to the invention is given by the appended claims together with their full range of equivalents.

What is claimed is:

1. A panel retention device, comprising:
a compression pad having a rectangular cross section and plate opposing surface;
a compression plate having a rectangular cross section, pad support surface facing the compression pad, and a disk support surface;
a threaded disk extending from the disk support surface; and
an adjustable flange removably threaded onto the threaded disk.

2. The panel retention device of claim 1, wherein the compression flange is a toothed flange

3. The panel retention device of claim 1, wherein the compression plate includes a plurality of alignment support receiving passageways

4. The panel retention device of claim 3, further comprising a pair of alignment supports positioned in the plurality of alignment support receiving passageways.

5. The panel retention device of claim 4, wherein the threaded disk is a cylindrical member having a body with a plurality of threads disposed along an outer surface thereof

6. The panel retention device of claim 5, wherein the threaded disk includes a plurality of cylindrically-shaped alignment support receiving sockets receiving the pair of alignment supports.

7. The panel retention device of claim 6, wherein the alignment supports are cylindrically-shaped, solid members and are sized to fit within the circumference of passageways and sockets.

8. The panel retention device of claim 7, wherein the adjustable flange is a disk-shaped member having a plurality of spaced teeth disposed along its circumference and extending away from a center thereof

9. The panel retention device of claim 8, wherein the plurality of teeth provides a plurality of tool-receiving notches between each tooth.

10. The panel retention device of claim 9, wherein the adjustable flange further includes a threaded disk receiving passageway extending through a body of the flange from front to back and completely there through.

11. The panel retention device of claim 10, wherein the threaded disk receiving passageway corresponds with the threaded disk. 12. A panel mount compression system comprising:
a U-shaped base shoe having a receiving channel formed by a bottom connecting a first sidewall and a second sidewall;
an L-shaped compression pad having a horizontal base portion and a vertical upright portion, the L-shaped compression pad positioned in the receiving channel adjacent to the first sidewall and adjacent to the bottom of the receiving channel of the base shoe;
a retention device positioned in the receiving channel and having:
a compression pad having a rectangular cross section and plate opposing surface;
a compression plate having a rectangular cross section, pad support surface facing the compression pad, and a disk support surface;
a threaded disk extending from the disk support surface; and
an adjustable flange removably threaded onto the threaded disk.

13. The panel retention device of claim 12, wherein the adjustable flange is a toothed flange

14. The panel retention device of claim 12, wherein the compression plate includes a plurality of alignment support receiving passageways

15. The panel retention device of claim 14, further comprising a pair of alignment supports positioned in the plurality of alignment support receiving passageways.

16. The panel retention device of claim 15, wherein the threaded disk is a cylindrical member having a body with a plurality of threads disposed along an outer surface thereof

17. The panel retention device of claim 16, wherein the threaded disk includes a plurality of cylindrically-shaped alignment support receiving sockets receiving the pair of alignment supports.

18. The panel retention device of claim 17, wherein the alignment supports are cylindrically-shaped, solid members and are sized to fit within the circumference of passageways and sockets.

19. The panel retention device of claim 18, wherein the adjustable flange is a disk-shaped member having a plurality of spaced teeth disposed along its circumference and extending away from a center thereof.

20. The panel retention device of claim 19, wherein the plurality of teeth provides a plurality of tool-receiving notches between each tooth. 21. The panel retention device of claim 20, wherein the adjustable flange further includes a threaded disk receiving passageway extending through a body of the flange from front to back and completely there through.

22. The panel retention device of claim 21, wherein the threaded disk receiving passageway corresponds with the threaded disk.
